(19) United States
(12) Patent Application Publication
(10) Pub. No.: US 2007/0035276 A1
(43) Pub. Date: Feb. 15, 2007

(54) Charging system for charging accumulator means in an electronic device, and a charging apparatus and an electronic device for the system

(76) Inventor: Mats Webjorn, Spanga (SE)

Correspondence Address: OSTROLENK FABER GERB & SOFFEN, 1180 AVENUE OF THE AMERICAS, NEW YORK, NY, 100368403, US

(21) Appl. No.: 10/572,028

(22) PCT Filed: Sep. 9, 2004
(86) PCT No.: PCT/SE04/01308

§ 371 Date: Mar. 13, 2006

Related U.S. Application Data
(60) Provisional application No. 60/481,352, filed on Sep. 10, 2003.

(30) Foreign Application Priority Data
Sep. 10, 2003 (SE) 0302415.5

(51) Int. Cl. H02J 7/00

(52) U.S. Cl. 320/114

(57) ABSTRACT

A charging system for charging accumulator means (2) in an electronic device (1) is provided, the electronic device (1) being adapted to be connected to a charging apparatus (4b) for charging the accumulator means (2). The charging apparatus (4b) is adapted to send, and the electronic device (1) is adapted to receive, and/or the electronic device (1) is adapted to send, and the charging apparatus (4b) is adapted to receive at least one signal according to a communication protocol for configuring the connection between the electronic device (1) and the charging apparatus (4b). Further, the electronic device (1) is adapted to be connected to an external electronic unit (4a), whereby the external electronic unit (4a) is adapted to send, and the electronic device (1) is adapted to receive, and/or the electronic device (1) is adapted to send, and the external electronic unit (4a) is adapted to receive at least one signal according to the communication protocol.

### TECHNICAL FIELD

The present invention refers to a charging system, and also to an electronic device, and a charging apparatus for the charging system.

### TECHNICAL BACKGROUND

Electronic devices having rechargeable accumulators, whether they are portable measuring devices, wireless computer keyboards, wireless mice, mobile terminals, simply electrical accumulators, or any other type of devices, have means to attach and connect a charger for the accumulators. Thereby, the charger required is usually of a certain type or model, often supplied to the user together with the electronic device.

In many cases, there is a need for more flexibility regarding the choice of charger for the device. For example, the user might not have the charger supplied to him together with the device handy, and he or she might be contemplating attaching a charger of another make or model to the device, without knowing if the charger specifications correspond to the requirements of the device to be charged.

On the other hand, in other cases, there may be a need for more selectability regarding the choice of charger for the device. For example, a manufacturer of the electronic device may want only certain types, makes or models of chargers to be used for the electronic device, and exclude the use of other chargers.

Some electronic devices having rechargeable accumulators are adapted to be attached and connected to an external electronic unit, for example a PC, for the exchange of data between the electronic device and the external electronic unit. Thereby, apart from a connector provided for an accumulator charger, a separate connector has to be provided on the device for attaching an external electronic unit. In mass production, the inclusion of two separate connectors requires additional parts and materials, is time consuming and therefore costly.

### SUMMARY

It is an object of the present invention to provide more flexibility for connecting an electronic device comprising electrical accumulators to chargers.

It is also an object of the present invention to provide more selectability for connecting an electronic device comprising electrical accumulators to chargers.

These objects are reached with a charging system, comprising an electronic device and a charging apparatus, the electronic device being adapted to be connected to the charging apparatus for charging accumulator means in the electronic device, whereby the charging apparatus is adapted to send, and the electronic device is adapted to receive, and/or the electronic device is adapted to send, and the charging apparatus is adapted to receive at least one signal according to a communication protocol for configuring the connection between the electronic device and the charging apparatus, in addition to which the electronic device is adapted to be connected to an external electronic unit, whereby the external electronic unit is adapted to send, and the electronic device is adapted to receive, and/or the electronic device is adapted to send, and the external electronic unit is adapted to receive at least one signal according to the communication protocol.

Thereby, upon physical attachment of the charging apparatus to the electronic device, certain properties of the configuration can be established, in order to proceed with accumulator charging, or possibly to suspend charging if certain un-desired qualities are present in the configuration. Properties established can include maximum charging power or current. Further, the communication protocol can be used to establish whether the electronic device is being connected to a charging apparatus or an external electronic unit. Upon establishment, a connection configuration can be set for the delivery of power or exchange of data depending on the combination at hand, whether it is a charger-device combination, or something else. In other words, when the charging apparatus and the electronic device are connected, the communication protocol can be used to establish this, and based on this establishment, the electronic device can be configured for the accumulator means to receive charging power from the charger in a manner as efficient as possible. As a result of this, the charging apparatus or some external electronic unit can be connected to the electronic device using the same connector in the latter. In general, it will provide a flexible system with an electronic device to be connected to a charger as well as an external electronic unit. This embodiment will also, by allowing one connector on the electronic device to be used for charging and other applications, simplify the design of the electronic device, reduce manufacturing time and material needed for it, and therefore reduce production costs of the device.

Preferably, the communication protocol specifies at least one mechanical property of at least one connector for connecting the electronic device and the charging apparatus, at least one electrical property of an electronic device interface and/or a charging apparatus interface, and a command set to be used by the charging apparatus to enumerate (identify) the electronic device. This provides for a large flexibility or selectability regarding the device-charger combination. For example, the invention can be used to allow charging of the accumulator means by chargers of only certain makes or models, or certain specified charging features, such as charging current.

Preferably, at least one application data set according to the communication protocol is stored in at least one electronic memory arranged in the electronic device, at least one of the application data sets including data requested according to the communication protocol for charging the accumulator means using the charging apparatus. Thereby, the electronic device can, by suitable entries in the electronic memory, be easily adapted for being connectable to a selected charger type or types. For example, by adding an application data set, the device can be adapted to be connected to a charger with specifications differing from other chargers, to which the device is adapted to be connected to. The application data set requested for charging the accumulator means can be arranged in any way in the electronic memory of the device, e.g. as a coherent entry. It could also be arranged in at least two data subsets distributed to different registers or similar of the memory or memories, whereby subscripts or pointers are used to link the subsets.

Preferably, at least one application data set comprises a configuration data set, whereby the charging apparatus is adapted to send at least one signal to the electronic device, so as to retrieve from the at least one electronic memory at least one of the configuration data sets, or a subset of at least one of the charger configuration data sets. Thereby, the system is provided with an effective method to establish and implement an appropriate configuration for the charging of the accumulator means.

Preferably, at least one of the application data sets comprises at least one power delivery scheme for power delivery from the external electronic unit or the charging apparatus to the electronic device. Thereby, power delivery can be adapted to requirements present when the electronic device is connected to an external electronic unit, and be re-adapted to requirements present when the electronic device is connected to a charging apparatus. In the latter case such requirements are usually very different to the requirements in the former case. For example, if the external electronic unit is a PC, power can be delivered to the electronic device for functions in the latter, but there could be requirements due to limitations in power delivery capabilities of the external electronic unit. Such requirements could change during the time of connection between the device and the unit. Thereby, the power delivery scheme for the connection could allow changing the power delivered in accordance with changing requirements. When a charger is connected to the electronic device, another power delivery scheme is applied, whereby optimal charging power for the accumulating means can be secured.

The objects of the invention are also reached by an electronic device according to claims 14-16, and a charging apparatus according to claims 17-24.

### DRAWING SUMMARY

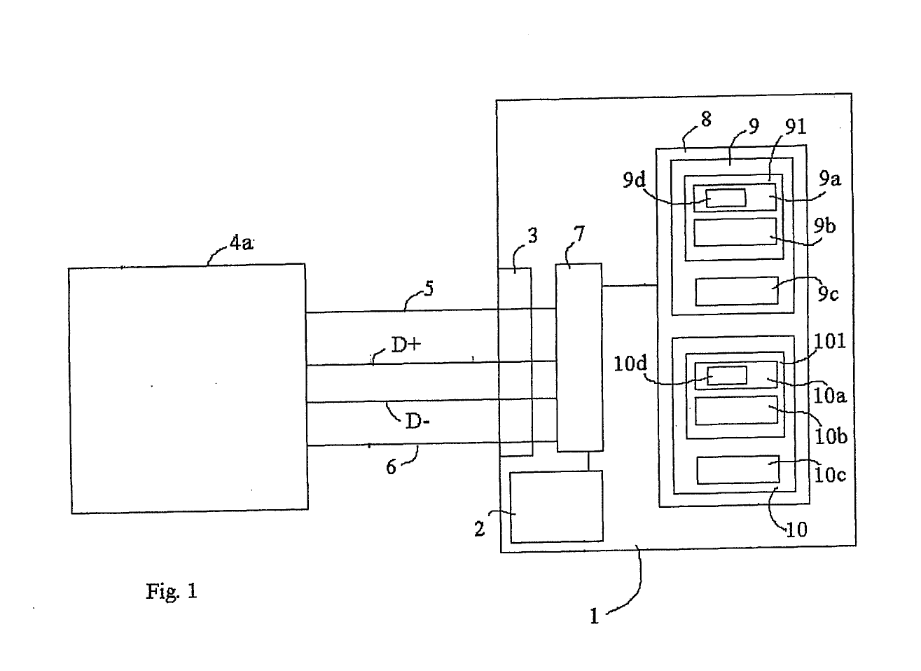

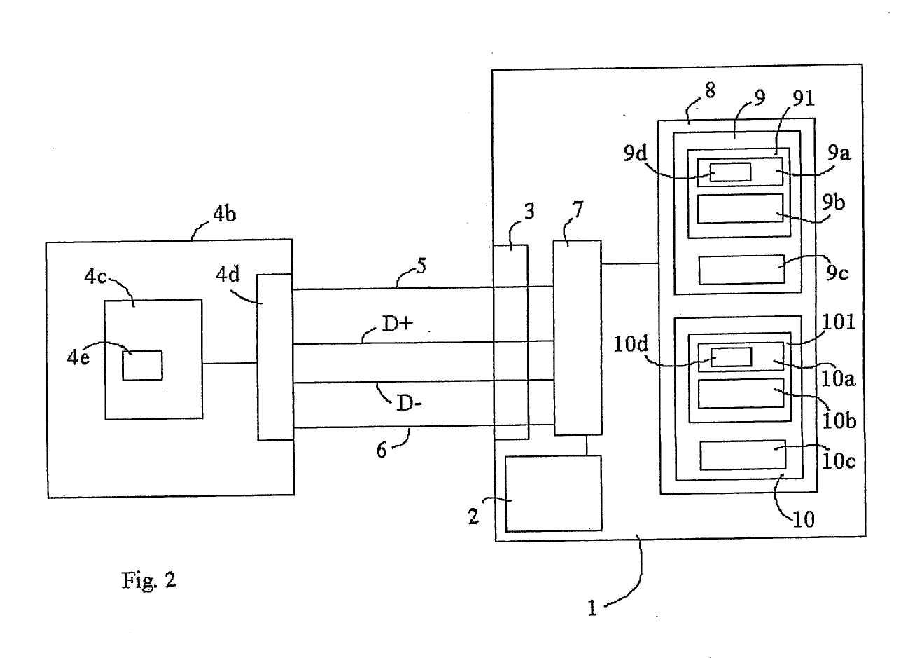

Further advantages of the invention will be disclosed below, where the invention will be described in greater detail with the aid of the accompanying drawings, in which FIGS. 1 and 2 are block diagrams for illustrating a system according to one embodiment of the invention.

### DETAILED DESCRIPTION

FIG. 1 is a block diagram in which an electronic device 1 is schematically depicted. The electronic device 1 comprises accumulator means in the form of one or more rechargeable batteries or accumulators. The electronic device 1 could be adapted to perform any of a number of functions associated with computer utilisation, telecommunication or other types of information technology, whereby power from the accumulator means can be used for enabling performance of such functions. For example, it could be a portable measuring device, a wireless human input device such as a wireless computer keyboard or a wireless mouse, or a mobile terminal.

The electronic device 1 comprises a connector 3 for connecting an external electronic unit 4a, e.g. via a flexible cord. For example, the external electronic unit 4a could be a personal computer (PC). Using computational and storage capabilities, described closer below, in the electronic device 1 and in the external electronic unit 4a, the external electronic unit 4a is adapted to send, and the electronic device is adapted to receive, and/or the electronic device is adapted to send, and the external electronic unit 4a is adapted to receive at least one signal, via a connection at the connector 3 and according to a communication protocol for configuring the connection between the electronic device 1 and the external electronic unit 4a. The communication protocol can specify the mechanical properties of the connectors of the electronic device 1 (including the connector 3) as well as the external electronic unit 4a, the electrical properties of the electronic device interface, as well as the external electronic unit 4a interface, and frame formats. The protocol can also specify a command set used by the external electronic device to enumerate (identify) the electronic device 1, and to determine if there are sufficient resources, such as bandwidth and power, in the external electronic unit 4a to accept the electronic device 1. This provides the electronic device 1 to be attached to an external electronic unit, such as a PC, via the connector 3, configuring the connection by means of the communication protocol, and thereafter using the connection for transfer of data, for any application, between the electronic device 1 and the external electronic unit.

The communication protocol can be a USB defined by the Universal Serial Bus Specification. USB is a standard defining a packet oriented communication protocol developed for simultaneously connecting a large number of devices such as printers, modems and keyboards to a host computer, e.g. a PC. As suggested in general above, the USB standard specifies mechanical properties of both the device and host cable connector, the electrical properties of both the device and host interface, the frame formats, and the command set used by the host to enumerate (identify) the device, and to determine if there are sufficient resources, such as bandwidth and power, on the bus to accept the device on the bus.

Referring to FIG. 2, according to the invention, the electronic device is adapted to be connected to a charging apparatus 4b, e.g. via a flexible cord, for charging the accumulator means 2 in the electronic device. Thereby, the charging apparatus 4b is connected to the electronic device 1 using the same connector 3 in the latter as when the external electronic unit 4a is connected to the electronic device 1. The charging apparatus 4b is equipped so as to have computing and data storing functions presented by processing and storing means 4c. The processing and storing means 4c of the charging apparatus can communicate with the electronic device 1 via a suitable connector 4d and a bus. Thereby, charging apparatus 4b is adapted to send, and the electronic device 1 is adapted to receive, and/or the electronic device 1 is adapted to send, and the charging apparatus 4b is adapted to receive at least one signal according to the communication protocol.

Preferably, the communication protocol is defined by the USB standard. In accordance therewith, four wires are used to convey power and signals between the charging apparatus 4b and the electronic device 1: a Vbus 5, which provides power, a ground 6, providing a power and signaling return path, D+ and D−, which are used together as a differential half-duplex signaling pair. D+ and D− are used by the external electronic unit 4a (see FIG. 1) or by the charging apparatus 4b (see FIG. 2) during the initial connection detect phase of an electrical protocol to detect the presence of the device 1. D+ and D− are used by the external electronic unit 4a or by the charging apparatus 4b to detect the operation speed of the electronic device 1.

Naturally, within the scope of the present invention, the means for conveying power and signals can be presented in any alternative suitable form, for example with an alternative number of wires.

Per definition in the USB standard, a host is always a power source and a device is always a power sink. When USB is used for this invention, both charging apparatuses and external electronic units, such as PC:s, are regarded as hosts according to USB nomenclature, and what is herein referred to as electronic devices are simply referred to as “devices” in USB nomenclature.

The electronic device 1 is provided with at least one data processor 7, connected to the connector 3, and in access of at least one electronic memory 8. The data processor 7 is a CPU, but alternatively it could be any kind of processing unit implementing the communication protocol. In the memory 8, at least two application data sets 9, 10, each according to the communication protocol, are stored. Each application data set 9, 10 comprises a configuration data set 91, 101. At least one of the application data sets 9, 10 is a unit application data set 9, comprising a unit configuration data set 91, and at least one of the application data sets 9, 10 is a charger application data set 10, comprising a charger configuration data set 101. Below, a configuration data set is also referred to simply as a configuration. Here, only two application data sets, and only two configurations are mentioned, but the memory could store a large amount of application data sets and configurations. Each configuration 91, 101, includes a configuration descriptor 9a, 10a, at least one interface descriptor 9b, 10b, and optionally end point and functional descriptors (not shown), each describing protocol parameters for some function of the electronic device 1. Associated with each configuration 91, 101, is a string descriptor 9c, 10c. An index in each configuration descriptor 9a, 10a points to a string descriptor 9c, 10c, which is used to identify the respective configuration descriptor 9a, 10a. For this presentation, the configuration descriptors 9a, 10a, and the interface descriptors 9b, 10b are also referred to as subsets of the respective configuration 91, 101. Additionally, for this presentation, the configurations, 91, 101, the configuration descriptors 9a, 10a, the interface descriptors 9b, 10b and the string descriptors 9c, 10c are also referred to as subsets of the respective application data set 9, 10.

The unit configuration 9 includes a unit configuration descriptor 9a, including an index to a unit string descriptor 9c. It should be noted that as an alternative the unit configuration 9 can be presented without a string descriptor 9c. In the latter case, the index in the configuration descriptor could indicate the absence of a string descriptor, for example by reading “0”. The unit configuration 9 includes data requested according to the communication protocol for establishing a connection between the external electronic unit 4a and the electronic device 1. More specifically, the interface descriptors in the configuration determine functions to be exposed to a unit or apparatus connected to the electronic device 1. For example, an interface descriptor could contain communication parameters for a human input device (HID).

Referring to FIG. 2, the charger configuration 101 includes at least one interface descriptor 10b for the charger function, and a charger configuration descriptor 10a, including an index to a charger string descriptor 10c. The charger string descriptor 10c has a unique value, preferably a GUID (Globally Unique ID). The charger configuration descriptor 10a and the interface descriptor 10b include data requested according to the communication protocol for connecting the charging apparatus 4b and the electronic device 1. Preferably, the interface descriptor 10b specifies a charger specific protocol, and it uses at least endpoint zero because it is mandatory to be present in all USB devices. The charger configuration 101 may also comprise at least one charger protocol specific functional descriptor that describes what options of the charger protocol that this particular electronic device 1 supports. Such options could include limits of the power delivery, for example, limits higher that the 500 mA limit in the USB specification. In the case of the USB standard being used, to exceed the 500 mA, the charger should be attached directly to the electronic device, i.e. without intermediate “hubs”.

Preferably, the charging apparatus 4b is provided with a command set, whereby it is arranged so as to run an enumeration process, whereby it sends and receives signals to and from the device 1 so as to retrieve the charger configuration 101. Thereby, the charging apparatus sends an index, from the processing and storing means 4c of the charging apparatus 4b, for retrieving a configuration 91, 101, corresponding to the index. Thereupon, the electronic device 1 sends the configuration corresponding to the index to the charging apparatus, whereby the charging apparatus retrieves the respective associated string descriptors 9c, 10c, where available, in the same manner. The string descriptor is compared to a search word 4e, stored in the processing and storing means 4c of the charging apparatus, and when the string descriptor matches the search word 4e, the charging apparatus 4b sends a signal to the device 1, with the index used to retrieve the configuration for which a match on the associated string descriptor was made, to set, or implement a configuration corresponding to the index.

As an alternative enumeration process, the charging apparatus 4b sends a search word 4e, corresponding to the string descriptor 10c of the charger application data set 10, to the electronic device 1, whereby the electronic device 1 sets, or implements, the charger configuration 101.

Preferably, before setting the configuration, it is determined whether the power request in the configuration is within the limits of the charger. If so the charging apparatus can select this configuration and the electronic device 1 may start charging its batteries 2. Otherwise it will stop all transactions on the bus so that the electronic device 1 can shut down its interface and reduce its power consumption to a minimum. In the latter case, if a charging indicator, or other charging progress display means is provided, this could be turned off or indicate a non-charging state.

It should be noted that the system according to the invention can be adapted so that the charger can accept a plurality of configurations stored in the memory of the electronic device. In other words, when the configurations, or subsets thereof, are read, any of a number of these can be identified, to be used in the charging process.

Preferably, the configuration descriptors are read in an order according to a selected numbering of the descriptors. Preferably, if the communication protocol is defined by the USB standard, the charger configuration descriptor, or descriptors, should not have the lowest number, since some major operating systems, which could be used in a PC, which could form an external electronic unit according to the nomenclature herein, automatically selects the configuration descriptor first read, i.e. the one with the lowest number.

Each configuration descriptor 9a, 9b comprises a power delivery scheme 9d, 10d for power delivery from the external electronic unit 4a or the charging apparatus 4b to the electronic device. Thereby, as explained above, power supply can be managed differently according to different requirements depending on what kind of unit or apparatus the electronic device 1 is connected to, i.e. the power discipline can be adapted to a configuration with an external electronic unit 4a or with a charging apparatus 4b. Of course, each power delivery scheme 9b, 10d can be arranged in an alternative manner in the respective application data set, e.g. distributed to separate subsets of the respective application data set.

It should be noted that the application data sets 9, 10 can be arranged in any suitable alternative manner, with or without string descriptors 9c, 10c for identification of the application data sets or the configurations. For example, each interface descriptor 9b, 10b in the configuration 91, 101 can be searched for some unique value or code identifying a function for the charging apparatus connection to the device. Thereby, coding of the functions could be chosen and implemented in any suitable manner. In each configuration the functions could be arranged according to a list. In the case of the communication protocol being defined by the USB standard, an interface descriptor 9b, 10b could be identified by the interface class, the interface sub-class and the interface protocol. In other words, all configurations could be scanned for an interface descriptor specifying a specific class and protocol code. But since this is an 24-bit value, is it a more un-secure solution when the class and protocol code may already be in use by some already existing product. Alternatively, in any suitable communication protocol, an application data set or a configuration could be possible to identify by allocating one or more parts of the application data set itself, or the configuration itself, to data used to identify the application data set or the configuration. Further, a list with values or codes, each identifying an application data set or a configuration could be scanned, without reading the configuration descriptors themselves during the scan, whereby, an entry in the list points to corresponding configuration data or a corresponding application data set once a match has been made.

By default subsets of, or the entirety of all application data sets can be scanned, or alternatively scanning can continue until an application data set or a configurations corresponding to predetermined requirements is found.

The invention described makes it possible for a manufacturer of the electronic device to provide support for a standard charger by using some standard string descriptor with the configuration. The manufacturer can also use a vendor specific string descriptor and in this way support only chargers of his or her own brand. Alternatively, the electronic device 1 may even expose several configurations so that the device supports a number of different chargers, standard and vendor specific.

Another advantage of the system according to the invention is that functions of the electronic device 1 that may be activated when the device is connected to an external electronic unit, such as OBEX (OBject EXchange), modem and mass-storage used on mobile terminals, will not be activated when the electronic device 1 is connected to the charging apparatus, since they will not be present in the charger configuration 101.

The system according to the invention does not imply large and costly design changes, in relation to existing systems. The minimum implication on the electronic device 1 for supporting the solution according to the invention is only the addition of an application data set 10 or a configuration 101 in the memory 8 of the electronic device 1, e.g. including a configuration descriptor 10a and a string descriptor 10c. If the configuration descriptor is within the standard USB protocol, the electronic device will be capable of handling an additional descriptor, and there is no need to add specific code support for a charger protocol, and support for optional commands may be omitted in some functional descriptor. If selected portions of the charger protocol are needed then of course some code has to be written to support this. Optional charger commands could provide functionality such as reading charging status from the device and enabling extended power consumption in excess of 500 mA for faster charging.

If USB is used to define the communication protocol, the charging apparatus can be implemented using a microcontroller with an embedded USB host. This, provides an easy implementation of the functions according of the charging apparatus according to the invention.

In the case of a USB interface being used, the invention allows the electronic device to use a standard USB B-type, mini-B-type, or mini-AB type connector, and allows the user to use standard cables. This is advantageous compared to using a proprietary connector for the USB charging cable, which has the disadvantages of increasing tooling costs, possibly increasing the required space, and being inconvenient for users.

The invention allows the use of standard electronics in the device, and requires, in relation to chargers according to known art, only a small addition of electronics to the charging apparatus. In addition, chargers can be standardized and used with a variety of devices, allowing economies of scale to reduce the price.

In addition to the advantages stated above, in cases where the communication protocol is defined by the USB standard, using a system according to the invention, will avoid some special problems, which will otherwise occur when connecting a charger to an electronic device. To illustrate this the example below is given.

Referring to the case where the electronic device 1 is connected to an external electronic unit, the following applies in case of USB being used as a standard for the communication protocol:

Compliant devices are required to follow the power disciplines given in the USB specification. These disciplines can be summarized as follows: Although the host (external electronic unit 4a) supplies some amount of power on the Vbus pin 5 (FIG. 1 #5), the specification allows the host to vary the amount of power supplied following certain rules. If the device doesn't follow the rules, it may cause system malfunctions. For example, over-current protection in a host port may be triggered, disabling the host port. For another example, system power supply design constraints may be violated, preventing the system from awakening from suspend.

The specification defines the following device states when it is physically connected to the host:
Attached: the device has been physically attached to the host, but Vbus is not powered. Using the 4 wires of USB, there is no way for a device to distinguish between this state and being physically disconnected; but the device might have some unspecified way of sensing that this connection is present.
Powered: the device is attached, Vbus is active, but has not been reset.
Default: the device is attached, Vbus is active, and the device has been reset at least once; but it has not been assigned a non-zero address since the last time it was reset.
Addressed: the device is attached, Vbus is active, and the device has been reset at least once; the device has been assigned a non-zero address, but the device has not been assigned a non-zero configuration value.
Configured: the device is attached, Vbus is active, and the device has been reset at least once; the device has been assigned a non-zero address, and the device has been assigned a non-zero configuration value.
Suspended: the device was most recently in one of the (Powered, Default, Addressed, or Configured) states, but no bus activity has occurred for at least 3 milliseconds. As long as there is no traffic, the device remains in the Suspended state. When traffic resumes, the device returns to its prior state.

Electrically, a device detects that it is in the Powered state by sensing that Vbus is present, relative to Ground. The host detects that a device is present by first supplying Vbus, and then checking for certain voltages on the pints that will become D+ and D−. Full speed and high-speed devices signal attachment by pulling D+ to Vbus using a 1500 ohm resistor. Low-speed devices signal attachment by pulling D− to Vbus using a 1500 ohm resistor.

The specification also notes that during the transition between Attached and Powered, there is the possibility that Vbus is supplied to the device, but the device does not signal to the host that the device is attached, (i.e., the D+ or D− pullup resistor is electrically disconnected or grounded). The compliance test procedure requires that devices must connect D+/D− to Vbus within 100 milliseconds of sensing Vbus.

The USB compliance test procedure requires that the devices follow these rules:
1. Initially, when the device is connected to the host, it enters the Powered state. The device may draw 100 mA from Vbus for up to 100 milliseconds; then it must enter the “Powered” state.
2. In the “Powered”, “Default” and “Addressed” state, the device may draw 100 mA, but must recognize absence of bus traffic and transition to the “Suspend” state.
3. In the “Configured” state, the device may draw as much power as was specified by the power delivery scheme 9d, 10d in the configuration descriptor 9a, 10a that corresponds to the configuration selected by the host.
4. In the “Suspend” state, the device may draw a maximum of 500 μA.

Now, a situation can be considered, in which the electronic device is attached to a charger according to known art using the Vbus, (FIG. 2 #5), and whereby the charger is connected to a standard USB socket on the device. This kind of charger does not generate any traffic on the USB bus. The device's USB section cannot distinguish between a charger and a normal USB host. Therefore, it must
1. signal attach within 100 milliseconds of the cable being attached
2. limit its current draw to 100 mA

3. correctly detect the suspend condition and reduce power consumption to 500 microamperes within 3 milliseconds after switching to the “Powered” state. Of course, once the device reduces its power consumption to 500 microamperes, charging becomes ineffective.

Since the invention, through the enumeration process described above, provides for establishing that the device is connected to a charger, this problem is avoided, and the batteries of the device can be charged with a high efficiency. In the case of a USB interface being used together with the system according to the invention, up to 500 mA can be provided for charging the accumulator means in the electronic device.

It should be noted that the electronic device 1 could also simply be an electrical accumulator to be connected to a charging device for supplying power to the former. Thereby, the connector 3 would substantially be used only to attach a charging apparatus 4b to the electronic device 1. Thereby, only one application data set according to the communication protocol could be stored in an electronic memory 8 arranged in the electronic device 1, whereby the application data set includes data requested according to the communication protocol for charging the accumulator means using the charging apparatus. Alternatively, two or more application data sets according to the communication protocol could be stored in the electronic memory 8, whereby at least two of the application data sets include data requested according to the communication protocol for charging the accumulator means using a charging apparatus. Thereby, each application data set could comprise functions for connection to a charger with certain specifications. Thus, at one occasion some charger with certain specifications, e.g. regarding charging current, could be connected to the device, and on another occasion another charger with different specifications could be connected to the device, using the same connector at all occasions.

Above, USB has been used as an example of a communication protocol for configuring a connection between an electronic device and a charging apparatus. However, other communication protocols of the so called master-slave type can be used.

1. A charging system comprising an electronic device (1) and a charging apparatus (4b), the electronic device (1) being adapted to be connected to the charging apparatus (4b) for charging accumulator means (2) in the electronic device (1), by means of a connector (3) attached to the electronic device, whereby the charging apparatus (4b) is adapted to send, and the electronic device (1) is adapted to receive, and/or the electronic device (1) is adapted to send, and the charging apparatus (4b) is adapted to receive at least one signal according to a communication protocol for configuring the connection between the electronic device (1) and the charging apparatus (4b), wherein at least one application data set (9, 10) according to the communication protocol is stored in at least one electronic memory (8) arranged in the electronic device (1), at least one of the application data sets (10) including data, requested according to the communication protocol, for charging the accumulator means (2) using the charging apparatus, and the charging apparatus (4b) is adapted to send at least one signal to the electronic device (1), so as for at least the application data set (10) including data for charging, or a subset (101, 10c) thereof, to be read by the charging apparatus (4b), wherein the application data set (10) or subset (101, 10c) thereof which is read by the charging apparatus (4b) is compared to data (4e) in data storing means (4c) of the charging apparatus (4b), in order for the charging apparatus to decide whether to proceed with accumulator charging, or to suspend charging if certain un-desired properties are present in the read application data set (10), or subset (101, 10c), characterized in that the charging apparatus (4b) is adapted to send at least one signal to the electronic device (1), so as to enable extended power consumption in excess of what is stipulated in the communication protocol and/or in at least one power delivery scheme (9d, 10d) for controlling the power delivery from the charging apparatus (4b) to the electronic device (1) and which is comprised in the at least one application data set (9, 10) of the electronic device (1).

2. A charging system according to claim 1, wherein at least one of the application data sets (9, 10) comprises a subset in the form of a string descriptor (9c, 10c), the charging apparatus (4b) being adapted to send at least one signal so as for a determination to be made whether a string descriptor (9c, 10c) matches the data (4e) in the charging apparatus data storing means (4c).

3. A charging system according to any one of the preceding claims, wherein the at least one application data set (9, 10) comprises a configuration data set (91, 101), and wherein the charging apparatus (4b) is adapted to send at least one signal to the electronic device (1), so as for a configuration data set (91,101) of one of the application data sets (9,10) to be set or implemented.

4. A charging system according to any of the preceding claims, wherein the electronic device (1) is also adapted to be connected to an external electronic unit (4a) by means of the connector (3), whereby the external electronic unit (4a) is adapted to send, and the electronic device (1) is adapted to receive, and/or the electronic device (1) is adapted to send, and the external electronic unit (4a) is adapted to receive at least one signal according to the communication protocol.

5. A charging system according to any of the preceding claims, wherein the communication protocol is packet oriented.

6. A charging system according to claim, 1 wherein the communication protocol is defined by the Universal Serial Bus (USB) specification.

7. A charging system according to claim 6, wherein the charging apparatus (4b) is provided with an embedded USB host.

8. A charging apparatus, adapted to be connected to an electronic device (1) for charging accumulator means (2) in the electronic device (1), whereby it is adapted to send to the electronic device (1), and/or receive from the electronic device (1) at least one signal according to a communication protocol for configuring the connection between the electronic device (1) and the charging apparatus (4b), wherein it is adapted to send at least one signal to the electronic device (1) so as to read at least one application data set (9, 10), or a subset (91, 101, 9c, 10c) of the at least one application data set (9, 10), according to the communication protocol, which at least one application data set (9, 10) or subset is stored in at least one electronic memory (8) arranged in the electronic device (1), and including data, requested according to the communication protocol, for charging the accumulator means (2) by using the charging apparatus, and the charging apparatus (4b) is adapted to read at least the application data set (10) including data for charging, or a subset (101, 10c) thereof, wherein it comprises data storing means (4c) and is adapted to compare data (4e) in said data storing means (4c) to the read application data set (9, 10), or subset (91, 101, 9c, 10c) thereof stored in the electronic memory of the electronic device, in order for the charging apparatus to decide whether to proceed with accumulator charging, or to suspend charging if certain un-desired properties are present in the read application data set (9, 10), or subset (91, 101, 9c, 10c), characterized in that it is adapted to send at least one signal to the electronic device (1), so as to enable extended power consumption in excess of what is stipulated in the communication protocol and/or in at least one power delivery scheme (9d, 10d) for controlling the power delivery from the charging apparatus (4b) to the electronic device (1) and which is comprised in the at least one application data set (9, 10) of the electronic device (1).

9. A charging apparatus according to claim 8, being adapted to send at least one signal so as for a determination to be made whether at least one of the application data sets (9, 10) which comprises a subset in the form of a string descriptor (9c, 10c), matches the data (4e) in the charging apparatus data storing means (4c).

10. A charging apparatus according to claim 8, being adapted to send at least one signal to the electronic device (1), so as for a configuration data set (91, 101) of the at least one application data set (9, 10) to be set or implemented.

11. A charging apparatus according to claim 8, provided with an embedded USB host.

12. An electronic device, adapted to be connected to a charging apparatus (4b) for charging accumulator means (2) in the electronic device (1), by means of a connector (3) attached to the electronic device, whereby it is adapted to send to the charging apparatus (4b), and/or receive from the charging apparatus (4b) at least one signal according to a communication protocol for configuring the connection between the electronic device (1) and the charging apparatus (4b), and wherein at least one application data set (9, 10) according to the communication protocol is stored in at least one electronic memory (8) arranged in the electronic device (1), and the at least one application data set (10) includes data requested according to the communication protocol for charging the accumulator means (2) using the charging apparatus, and the at least one application data set (10) comprising data for charging, or a subset (101, 10c) thereof, is adapted to be read by the charging apparatus (4b), wherein the read application data set, or subset thereof, is adapted to be compared to data (4e) in data storing means (4c) of the charging apparatus (4b), in order to enable the charging apparatus to decide whether to proceed with accumulator charging, or to suspend charging if certain un-desired properties are present in the read application data set (9, 10), or subset (91, 101, 9c, 10c), characterized in that it is adapted to receive at least one signal from the charging apparatus (4b), enabling extended power consumption in excess of what is stipulated in the communication protocol and/or in at least one power delivery scheme (9d, 10d) for controlling the power delivery from the charging apparatus (4b) to the electronic device (1) and which is comprised in the at least one application data set (9, 10) of the electronic device (1).

13. An electronic device according to claim 12, wherein at least one of the application data sets (9, 10) comprises a subset in the form of a string descriptor (9c, 10c).

14. An electronic device according to claim 12, wherein at least one application data set (9, 10) comprises a configuration data set (91, 101).

15. An electronic device according to claim 12, adapted to be connected to an external electronic unit (4a), whereby it is adapted to send to the external electronic unit (4a), and/or receive from the external electronic unit (4a) at least one signal according to the communication protocol.

16. An electronic device according to claim 14, wherein at least one application data set (9, 10) comprises at least one power delivery scheme (9d, 10d) for power delivery from the external electronic unit (4a) or the charging apparatus (4b) to the electronic device (1).

17. An electronic device according to claim 12, wherein the same connector (3) can be used for both a charging apparatus (4b) and an external electronic unit (4a).
